(19) United States
(12) Patent Application Publication
(10) Pub. No.: US 2026/0162285 A1
(43) Pub. Date: Jun. 11, 2026

(54) DEPTH SENSOR

(71) Applicant: SK hynix Inc., Gyeonggi-do (KR)

(72) Inventor: Ji Hee HAN, Gyeonggi-do (KR)

(21) Appl. No.: 19/242,975

(22) Filed: Jun. 19, 2025

(30) Foreign Application Priority Data
Dec. 11, 2024 (KR) 10-2024-0183534

(51) Int. Cl. G06T 7/521; H04N 23/56; H04N 23/667

(52) U.S. Cl. CPC G06T 7/521; H04N 23/56; H04N 23/667; G06T 2207/10028

(57) ABSTRACT

The embodiments of the present disclosure relate to a depth sensor including an adjuster configured to adjust a size of region of interest corresponding to a position of at least one projected dot based on an image having the projected dot, the position varying according to a depth from a subject; and a detector configured to detect the projected dot based on the adjusted region of interest and the image.

### CROSS-REFERENCE TO RELATED APPLICATION(S)

This application claims priority under 35 U.S.C. § 119 to Korean Patent Application No. 10-2024-0183534, filed on Dec. 11, 2024, the disclosure of which is incorporated herein by reference in its entirety.

### BACKGROUND

### 1. Field

Various embodiments of the present disclosure relate to a semiconductor design technique, and more particularly, to a depth sensor that measures a depth to a subject.

### 2. Description of the Related Art

LiDAR is one of depth sensors mainly used to measure a distance, i.e., a depth, to a subject. The LiDAR accumulates a hit count value of incident light, e.g., a laser, reflected and returned from the subject in a plurality of time bins and acquires the distance based on a time bin with the largest hit count value among the plurality of time bins.

The incident light reflected and returned from the subject is projected in the form of dots through an image sensor mounted on the LiDAR. The position of the dots projected on the image sensor varies differently depending on the distance and/or a pixel region of the image sensor.

### SUMMARY

Various embodiments of the present disclosure are directed to a depth sensor capable of accurately detecting positions of projected dots when incident light, e.g., a laser, reflected and returned from a subject is projected on an image sensor.

In accordance with an embodiment of the present disclosure, a depth sensor may include an adjuster configured to adjust a size of region of interest corresponding to a position of at least one projected dot based on an image having the projected dot, the position varying according to a depth from a subject; and a detector configured to detect the projected dot based on the adjusted region of interest and the image.

In accordance with an embodiment of the present disclosure, a depth sensor may include a mode selector configured to generate, based on a mode control signal, a mode selection signal indicating one of a plurality of depth output modes; an adjuster configured to adjust a size of at least one region of interest corresponding to positions of some or all of a plurality of projected dots based on an image having the plurality of projected dots and the mode selection signal, the positions varying according to a depth from a subject; and a detector configured to detect the some or all of the plurality of projected dots based on the adjusted region of interest and the image.

In accordance with an embodiment of the present disclosure, a depth sensor may include a light emitter configured to emit output light; an image sensor configured to sense input light, which is the output light reflected from a subject, and generate an image having projected dots corresponding to the input light; and an image processor configured to generate a depth map based on the image by adjusting, according to a depth from the subject, a size of each region of interest to detect some or all of the projected dots.

### BRIEF DESCRIPTION OF THE DRAWINGS

FIG. 1 is a block diagram illustrating a depth sensor in accordance with an embodiment of the present disclosure.

FIG. 2 is a block diagram illustrating a pixel array included in an image sensor illustrated in FIG. 1.

FIG. 3 is a block diagram illustrating an image processor illustrated in FIG. 1.

FIGS. 4 to 9 are diagrams illustrating an operation of a depth sensor in accordance with an embodiment of the present disclosure.

### DETAILED DESCRIPTION

Various embodiments of the present disclosure are described below with reference to the accompanying drawings, in order to describe in detail the embodiments of the present disclosure so that those with ordinary skill in art to which the present disclosure pertains may easily carry out the technical spirit of the present disclosure.

It will be understood that when an element is referred to as being “connected to” or “coupled to” another element, the element may be directly connected to or coupled to the another element, or electrically connected to or coupled to the another element with one or more elements interposed therebetween. In addition, it will also be understood that the terms “comprises,” “comprising,” “includes,” and “including” when used in this specification do not preclude the presence of one or more other elements, but may further include or have the one or more other elements, unless otherwise mentioned. In the description throughout the specification, some components are described in singular forms, but the embodiments are not limited thereto, and it will be understood that the components may be formed in plural.

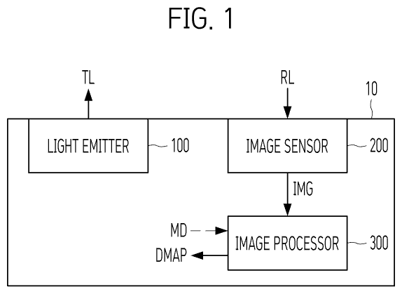

FIG. 1 is a block diagram illustrating a depth sensor 10 in accordance with an embodiment of the present disclosure.

Referring to FIG. 1, the depth sensor 10 may measure a distance, i.e., a depth, to at least one subject (not illustrated) distributed in a field of view. For example, the depth sensor 10 may include LiDAR. The depth sensor 10 may include a light emitter 100, an image sensor 200, and an image processor 300.

The light emitter 100 may emit output light TL toward the field of view. For example, the light emitter 100 may include a vertical cavity surface emitting laser (VCSEL) driver. When the output light TL hits the subject, incident light RL is reflected from the subject.

The image sensor 200 may sense the incident light RL, e.g., a laser, reflected from the subject and generate an input image IMG. The incident light RL may appear as projected dots, e.g., laser dots, on the image sensor 200. The projected dots may be formed on the image sensor 200 in a mesh form, and the image sensor 200 may generate the input image IMG having the projected dots.

Positions of the projected dots may change or shift depending on parameters related to the image sensor 200. The parameters may include a first parameter corresponding to the depth between the subject and the image sensor 200 and a second parameter corresponding to a position of a pixel region included in the image sensor 200.

The image processor 300 may generate a depth map DMAP based on the image IMG and a mode control signal MD and flexibly adjust the size of each region of interest for detecting some or all of the projected dots when generating the depth map DMAP. Although it is described as an embodiment of the present disclosure that the image processor 300 receives the mode control signal MD, the embodiment is not necessarily limited thereto. Depending on design, the image processor 300 may not receive the mode control signal MD.

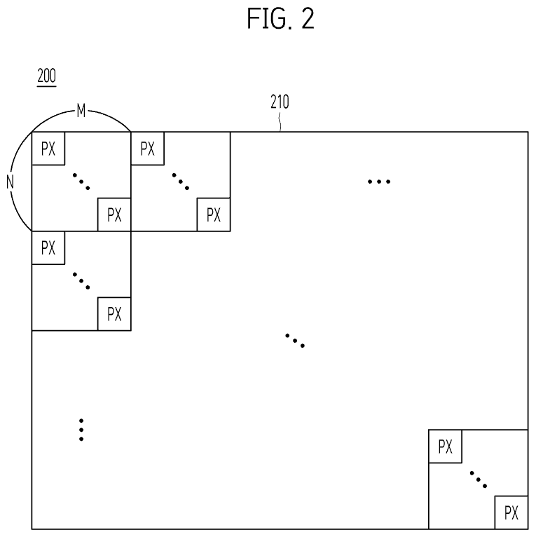

FIG. 2 is a block diagram illustrating a pixel array 210 included in the image sensor 200 illustrated in FIG. 1.

Referring to FIG. 2, the pixel array 210 may include a plurality of pixels PX for detecting the projected dots. The plurality of pixels PX may be arranged at intersections of a plurality of columns and a plurality of rows. For example, the pixel array 210 may include a single-photon avalanche diode (SPAD) array, and the plurality of pixels PX may each include a SPAD. Hereinafter, it is described that the plurality of pixels PX are grouped into N*M groups, where “N” is a natural number greater than or equal to 1, and “M” is a natural number greater than or equal to 2, and the grouped pixel groups are each referred to as the “pixel region”.

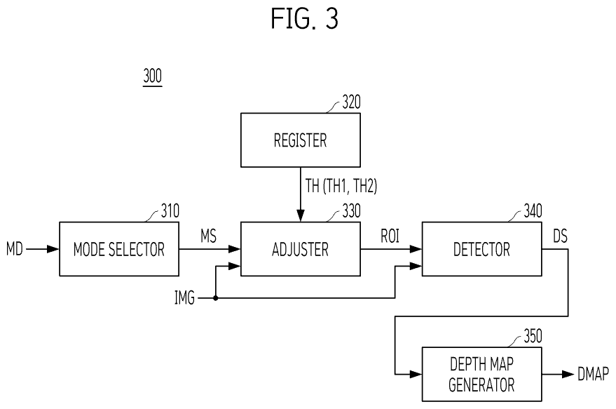

FIG. 3 is a block diagram illustrating the image processor 300 illustrated in FIG. 1.

Referring to FIG. 3, the image processor 300 may include a mode selector 310, a register 320, an adjuster 330, a detector 340, and a depth map generator 250.

The mode selector 310 may generate a mode selection signal MS corresponding to one of a first depth output mode and a second depth output mode, based on the mode control signal MD. The first depth output mode, which is a low speed mode, may be used when a depth map DMAP having a high resolution is generated. The second depth output mode, which is a high speed mode, may be used when the depth map DMAP having a low resolution is generated.

The register 320 may store threshold information TH for defining ranges of the depth. For example, the threshold information TH may include a first threshold value TH1 and a second threshold value TH2 for each pixel region, or include a first threshold value TH1 and a second threshold value TH2 for each pixel region group. The pixel region group may include pixel regions grouped according to arrangement positions of the pixel regions, or include pixel regions grouped according to degrees of movement of the projected dots.

The adjuster 330 may flexibly adjust the size of each region of interest corresponding to the positions of some or all of the projected dots that vary according to the depth, based on the image IMG and the mode selection signal MS. The adjuster 330 may determine a quantity of target dots corresponding to the some or all of the projected dots for each pixel region and flexibly adjust the size of each region of interest corresponding to positions of the target dots for each pixel region.

For example, the adjuster 330 may determine all of the projected dots as the target dots according to the first depth output mode and flexibly adjust the size of each region of interest corresponding to the target dots. In contrast, the adjuster 330 may determine some of the projected dots as the target dots according to the second depth output mode and flexibly adjust the size of each region of interest corresponding to the target dots.

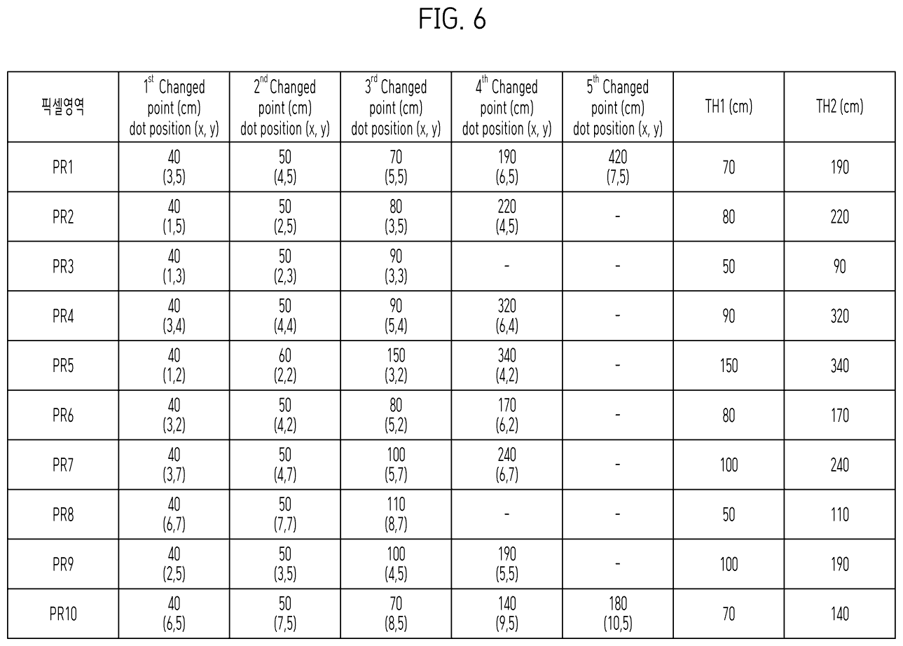

The adjuster 330 may adjust a size of the region of interest based on the threshold information TH. For example, the adjuster 330 may adjust the size of the region of interest to a first size ROI1 when the depth falls in a short range, adjust the size of the region of interest to a second size ROI2 smaller than the first size ROI1 when the depth falls in a medium range, and adjust the size of the region of interest to a third size ROI3 smaller than the second size ROI2 when the depth falls in a long range. That is, the adjuster 330 may adjust the size of the region of interest to be larger as the depth is closer and adjust the size of the region of interest to be smaller as the depth becomes farther. The short range, the medium range and the long range may be defined according to the first threshold value TH1 and the second threshold value TH2 and may be the same as or different from one another for each pixel region, which will be described with reference to FIG. 6.

The adjuster 330 may adjust the size of region of interest by adjusting one of vertical and horizontal sizes of the region of interest while fixing the other one of the vertical and horizontal sizes. When the light emitter 100 and the image sensor 200 are physically arranged as illustrated in FIG. 1, that is, when the image sensor 200 is arranged on the right side of the light emitter 100, the projected dots may have the tendency of gradually shifting to the right as the depth becomes farther. In this case, the adjuster 330 may adjust the size of region of interest by adjusting the horizontal size of the region of interest while fixing the vertical size of the region of interest.

The detector 340 may detect some or all of the projected dots based on the image IMG and the region of interest having one of the first to third sizes ROI1 to ROI3, which are represented as “ROI” in FIG. 3. For example, the detector 340 may generate dot information DS corresponding to all of the projected dots during the first depth output mode. Although not illustrated, the dot information DS generated during the first depth output mode may be used when the depth map DMAP having the high resolution is generated. Alternatively, the detector 340 may generate the dot information DS corresponding to some of the projected dots during the second depth output mode. Although not illustrated, the dot information DS generated during the second depth output mode may be used when the depth map DMAP having the low resolution is generated.

The depth map generator 350 may generate the depth map DMAP based on the dot information DS. For example, the depth map generator 350 may generate the depth map DMAP having the high resolution, based on the dot information DS during the first depth output mode. Alternatively, the depth map generator 350 may generate the depth map DMAP having the low resolution, based on the dot information DS during the second depth output mode.

Although it is described as an embodiment of the present disclosure that the mode selector 310 is included in the image processor 300, the embodiment is not limited thereto, and the mode selector 310 may not be included in the image processor 300. When the mode selector 310 is not included, the adjuster 330 may operate during a predetermined one of the first depth output mode and the second depth output mode, depending on design.

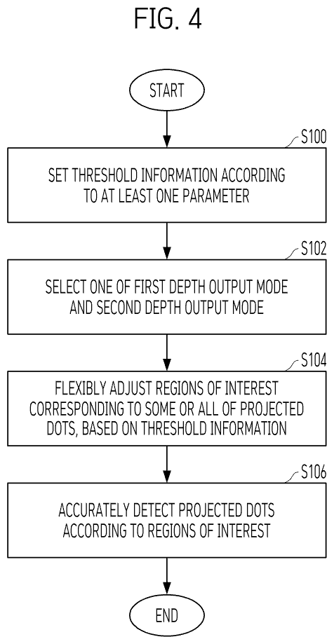

Hereinafter, an operation of the depth sensor 10 in accordance with an embodiment of the present disclosure, which has the above-described configuration, is described with reference to FIGS. 4 to 9.

FIG. 4 is a flowchart illustrating the operation of the depth sensor 10 illustrated in FIG. 1.

Referring to FIG. 4, the depth sensor 10 may set the threshold information TH according to the parameters in operation S100. For example, the parameters may include the first parameter corresponding to the depth between the subject and the image sensor 200 and the second parameter corresponding to the position of the pixel region included in the image sensor 200. For example, the threshold information TH may include the first threshold value TH1 and the second threshold value TH2 for each pixel region, or include the first threshold value TH1 and the second threshold value TH2 for each pixel region group. The pixel region group may include pixel regions grouped according to arrangement patterns of the pixel regions, or include pixel regions having similar degrees of movement of projected dots.

The depth sensor 10 may select one of the first depth output mode and the second depth output mode based on the mode control signal MD in operation S102. The first depth output mode, which is the low speed mode, may be used when the depth map DMAP having the high resolution is generated. The second depth output mode, which is the high speed mode, may be used when the depth map DMAP having the low resolution is generated.

The depth sensor 10 may flexibly adjust sizes of regions of interest corresponding to some or all of the projected dots, based on the threshold information TH in operation S104. For example, the depth sensor 10 may determine all of the projected dots as the target dots during the first depth output mode and flexibly adjust the sizes of regions of interest corresponding to the target dots. The adjuster 330 may determine some of the projected dots as the target dots during the second depth output mode and flexibly adjust the sizes of regions of interest corresponding to the target dots.

The depth sensor 10 may accurately detect the projected dots according to the adjusted regions of interest in operation S106. For example, the depth sensor 10 may adjust the sizes of the regions of interest to be larger as the depth is closer and adjust the sizes of the regions of interest to be smaller as the depth becomes farther. The depth may be divided into the short range, the medium range and the long range according to the first threshold value TH1 and the second threshold value TH2.

Among the operations S100 to S106 illustrated in FIG. 4, the operation S100 of setting the threshold information TH may be performed during a mode prior to a normal mode, for example, a test mode and a simulation mode, and the other operations S102 to S106 may be performed during the normal mode.

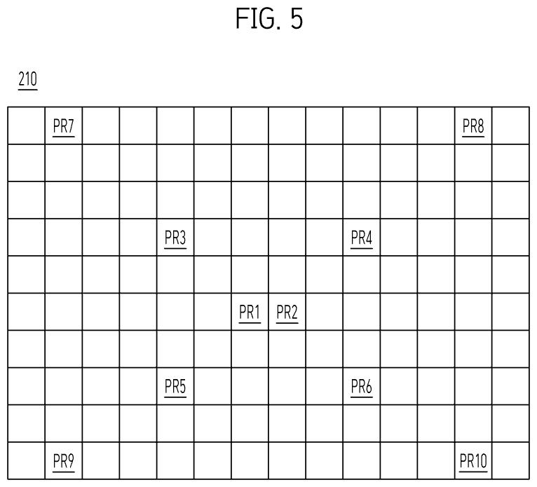

FIGS. 5 and 6 are diagrams for additionally describing the operation S100 of setting the threshold information TH among the operations described with reference to FIG. 4.

FIG. 5 is a schematic diagram illustrating the pixel array 210 including pixel regions, and FIG. 6 is a table for describing threshold information TH of pixel regions PR1 to PR10 as samples among the pixel regions included the pixel array 210. For convenience in description, FIGS. 5 and 6 illustrate only the threshold information TH of the sample pixel regions PR1 to PR10 among the pixel regions included in the pixel array 210. The table illustrated in FIG. 6 shows changed points and the threshold information TH according to the changed points. The changed points may represent the changes of depth. The depth sensor 10 captures a flat object multiple times at 10 cm intervals. The table illustrated in FIG. 6 also shows the geographical shifts of dots projected on the pixel regions PR1 to PR10 as the depth changes.

Referring to FIGS. 5 and 6, the dots projected on the pixel regions PR1 to PR10 may shift in a certain direction as the depth becomes farther. The threshold information TH may be set according to the degree of shift according to the depth. The dot projected on the first pixel region PR1 among the pixel regions PR1 to PR10 is representatively described below.

When the depth corresponds to a first changed point 40 cm, the position of the dot projected on the first pixel region PR1 may correspond to coordinates (3,5). When the depth corresponds to a second changed point 50 cm, the position of the dot projected on the first pixel region PR1 may correspond to coordinates (4,5). When the depth corresponds to a third changed point 70 cm, the position of the dot projected on the first pixel region PR1 may correspond to coordinates (5,5). When the depth corresponds to a fourth changed point 190 cm, the position of the dot projected on the first pixel region PR1 may correspond to coordinates (6,5). When the depth corresponds to a fifth changed point 420 cm, the position of the dot projected on the first pixel region PR1 may correspond to coordinates (7,5). As the depth becomes farther, only the value of the “X” coordinate among the position values included in the coordinates (X, Y) changes. In particular, as the depth becomes farther, the value of the “X” coordinate increases, and thus it may be seen that the position of the dot projected on the first pixel region PR1 shifts relatively to the right.

In this case, it may be seen that a variance of the depth from the third changed point 70 cm to the fourth changed point 190 cm is relatively large, and a variance of the depth from the fourth changed point 190 cm to the fifth changed point 420 cm is also relatively large. Therefore, as the threshold information TH of the first pixel region PR1, the first threshold value TH1 corresponding to the third changed point 70 cm and the second threshold value TH2 corresponding to the fourth changed point 190 cm may be set.

As illustrated in FIG. 6, the dots projected on the pixel regions PR1 to PR10 may differ for each depth and/or pixel region. Accordingly, the threshold information TH of the pixel regions PR1 to PR10 may differ for each pixel region.

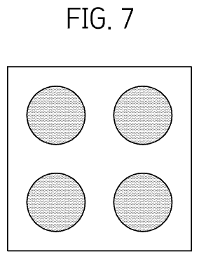

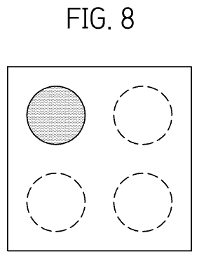

FIG. 7 and FIG. 8 are diagrams for additionally describing the operation S102 of selecting one of the first depth output mode and the second depth output mode among the operations described with reference to FIG. 4.

FIG. 7 is a schematic diagram illustrating an arbitrary pixel region for describing the first depth output mode. For example, the arbitrary pixel region may correspond to each of the pixel regions included in the pixel array 210.

Referring to FIG. 7, four dots, i.e., 2*2 laser dots, may be projected on the arbitrary pixel region. The first depth output mode, which is the low speed mode, may be used when the depth map DMAP having the high resolution is generated. During the first depth output mode, the depth sensor 10 may simultaneously or sequentially detect and use all of the four dots.

Referring to FIG. 8, four dots, i.e., the 2*2 laser dots, may be projected on the arbitrary pixel region. The second depth output mode, which is the high speed mode, may be used when the depth map DMAP having the low resolution is generated. During the second depth output mode, the depth sensor 10 may detect and use some of the four dots, for example, one dot.

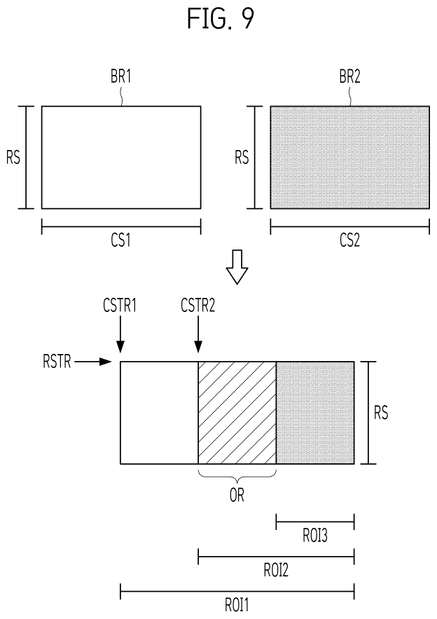

FIG. 9 is a diagram for additionally describing the operation S104 of flexibly adjusting regions of interest corresponding to some or all of the projected dots among the operations described with reference to FIG. 4. For example, FIG. 9 is a schematic diagram for describing an operation of adjusting the size of each of the regions of interest.

Referring to FIG. 9, the depth sensor 10 may adjust the size of region of interest by adjusting one of vertical and horizontal sizes of the region of interest while fixing the other one of the vertical and horizontal sizes. For example, when the projected dots gradually shift to the right as the depth becomes farther, the depth sensor 10 may adjust the size of region of interest by adjusting the horizontal size of the region of interest while fixing the vertical size of the region of interest. A method of adjusting the horizontal size while fixing the vertical size is described below.

The depth sensor 10 may generate the region of interest having first to third sizes ROI1, ROI2 and ROI3 through first and second basic regions BR1 and BR2. The first basic region BR1 may be predetermined to have a row size RS and a first column size CS1 and the second basic region BR2 may be predetermined to have the row size RS and a second column size CS2. The first column size CS1 and the second column size CS2 may be the same as or different from each other. For example, the depth sensor 10 may generate the region of interest having the first to third sizes ROI1, ROI2 and ROI3 by overlapping a right part of the first basic region BR1 and a left part of the second basic region BR2. The first size ROI1 may correspond to an entire region including the overlap OR between the first and second basic regions BR1 and BR2 and the respectively remaining parts of the first and second basic regions BR1 and BR2. The overlap OR between the first and second basic regions BR1 and BR2 may be formed by overlapping the first and second basic regions BR1 and BR2. The second size ROI2 may correspond to the second basic region BR2. The third size ROI3 may correspond to the remaining part other than the overlap OR within the second basic region BR2.

The depth sensor 10 may generate the region of interest having the first to third sizes ROI1, ROI2 and ROI3, based on the row size RS and the first column size CS1 of the first basic region BR1, the row size RS and the second column size CS2 of the second basic region BR2, a row start point RSTR, a first column start point CSTR1 and a second column start point CSTR2.

When the depth falls in the short range, the region of interest having the first size ROI1 may be used. As described above with reference to FIG. 6, because the projected dot has large variability at the short range, the region of interest having the relatively large first size ROI1 may be used. When the depth falls in the long range, the region of interest having the third size ROI3 may be used. As described above with reference to FIG. 6, because the projected dot has small variability at the long range, the region of interest having the relatively small third size ROI3 may be used.

According to an embodiment of the present disclosure, the size of a region of interest may be adjusted to be relatively large when the depth from a subject falls in a short range, which makes it possible to cover the variability of a projected dot as much as possible. In addition, the size of the region of interest may be adjusted to be relatively small when the depth falls in a long range, which makes it possible to minimize noise components reflected on the projected dot.

According to an embodiment of the present disclosure, positions of projected dots may be accurately detected when incident light, e.g., a laser, reflected and returned from a subject is projected on an image sensor. Accordingly, operational reliability of a depth sensor may be improved.

While the embodiments of the present disclosure have been illustrated and described with respect to specific embodiments, the disclosed embodiments are provided for description and not intended to be restrictive. Further, it is noted that the embodiments of the present disclosure may be achieved in various ways through substitution, change, and modification that fall within the scope of the following claims, as those skilled in the art will recognize in light of the present disclosure. The embodiments may be combined to form additional embodiments.

What is claimed is:

1. A depth sensor comprising:
an adjuster configured to adjust a size of region of interest corresponding to a position of at least one projected dot based on an image having the projected dot, the position varying according to a depth from a subject; and
a detector configured to detect the projected dot based on the adjusted region of interest and the image.

2. The depth sensor of claim 1, wherein the adjuster adjusts the size based on threshold information for defining ranges of the depth.

3. The depth sensor of claim 2, further comprising a register configured to store the threshold information.

4. The depth sensor of claim 1, wherein:
the adjuster adjusts the size to a first size when the depth falls in a short range, to a second size when the depth falls in a medium range, and to a third size when the depth falls in a long range, and
the second size is smaller than the first size and the third size is smaller than the second size.

5. The depth sensor of claim 4, wherein:
the first size corresponds to an overlap between predetermined first and second regions,
the second size corresponds to the second region, and
the third size corresponds to a remaining region other than the overlap within the second region.

6. The depth sensor of claim 1, wherein the adjuster adjusts the size by adjusting one of vertical and horizontal sizes of the region of interest while fixing the other one of the vertical and horizontal sizes.

7. A depth sensor comprising:
a mode selector configured to generate, based on a mode control signal, a mode selection signal indicating one of a plurality of depth output modes;
an adjuster configured to adjust a size of at least one region of interest corresponding to positions of some or all of a plurality of projected dots based on an image having the plurality of projected dots and the mode selection signal, the positions varying according to a depth from a subject; and
a detector configured to detect the some or all of the plurality of projected dots based on the adjusted region of interest and the image.

8. The depth sensor of claim 7, wherein the adjuster adjusts the size by:
determining, for each pixel region, a quantity of target dots corresponding to the some or all of the plurality of projected dots, and
adjusting the size of the region of interest corresponding to positions of the target dots for each pixel region.

9. The depth sensor of claim 7, wherein the adjuster adjusts the size based on threshold information for defining ranges of the distance.

10. The depth sensor of claim 9, further comprising a register configured to store the threshold information.

11. The depth sensor of claim 7, wherein:
the adjuster adjusts the size a first size when the distance falls in a short range, to a second size when the distance falls in a medium range, and to a third size when the distance falls in a long range, and
the second size is smaller than the first size and the third size is smaller than the second size.

12. The depth sensor of claim 11, wherein:
the first size corresponds to an overlap between predetermined first and second regions,
the second size corresponds to the second region, and
the third size corresponds to a remaining region other than the overlap within the second region.

13. The depth sensor of claim 7, wherein the adjuster adjusts the size by adjusting one of vertical and horizontal sizes of the region of interest while fixing the other one of the vertical and horizontal sizes.

14. The depth sensor of claim 7,
wherein the detector is further configured to generate dot information corresponding to the all of the plurality of projected dots when the mode selection signal indicates a low speed mode among the plurality of depth output modes, the dot information corresponding to the all projected dots being utilized for a depth map having a high resolution,
wherein the detector is further configured to generate dot information corresponding to the some of the plurality of projected dots when the mode selection signal indicates a high speed mode among the plurality of depth output modes, the dot information corresponding to the some projected dots being utilized for a depth map having a low resolution.

15. A depth sensor comprising:
a light emitter configured to emit output light;
an image sensor configured to sense input light, which is the output light reflected from a subject, and generate an image having projected dots corresponding to the input light; and
an image processor configured to generate a depth map based on the image by adjusting, according to a depth from the subject, a size of each region of interest to detect some or all of the projected dots.

16. The depth sensor of claim 15, wherein:
the image processor adjusts the size of a corresponding region of interest to a first size when the depth falls in a short range, to a second size when the depth falls in a medium range, and to a third size when the depth falls in a long range, and
the second size is smaller than the first size and the third size is smaller than the second size.

17. The depth sensor of claim 16, wherein:
the first size corresponds to an overlap between predetermined first and second regions,
the second size corresponds to the second region, and
the third size corresponds to a remaining region other than the overlap within the second region.

18. The depth sensor of claim 15, wherein the image processor includes:
an adjuster configured to adjust the size of each region of interest corresponding to positions of the projected dots based on the image, the positions varying according to the depth; and
a detector configured to detect the projected dots based on the adjusted region of interest and the image.

19. The depth sensor of claim 15, wherein the image processor includes:
a mode selector configured to generate, based on a mode control signal, a mode selection signal indicating a high speed mode or a low speed mode;
an adjuster configured to adjust, for each pixel region, the size of each region of interest based on the image and the mode selection signal, the region of interest corresponding to positions of the some of the projected dots when the mode selection signal indicates the high speed mode and corresponding to positions of the all of the projected dots when the mode selection signal indicates the low speed mode; and
a detector configured to detect the some or all of the projected dots based on the adjusted region of interest and the image.

20. The depth sensor of claim 19,
wherein the detector is further configured to generate dot information corresponding to the all of the projected dots when the mode selection signal indicates the low speed mode, the dot information corresponding to the all projected dots being utilized for a depth map having a high resolution,
wherein the detector is further configured to generate dot information corresponding to the some of the projected dots when the mode selection signal indicates the high speed mode, the dot information corresponding to the some projected dots being utilized for a depth map having a low resolution.
